(19) United States
(12) Patent Application Publication
(10) Pub. No.: US 2021/0002994 A1
(43) Pub. Date: Jan. 7, 2021

(54) METHOD FOR CREATING BRANCH FRACTURES IN OIL WELLS

(71) Applicant: Xi'an Shiyou University, Xi'an (CN)

(72) Inventors: Desheng ZHOU, Xi'an (CN); Haiyang WANG, Xi'an (CN); Peiyao XIAO, Xi'an (CN); Xinru LI, Xi'an (CN); Wenbin CAI, Xi'an (CN); Shun LIU, Xi'an (CN); Yafei LIU, Xi'an (CN); Xiong LIU, Xi'an (CN); Xianlin MA, Xi'an (CN); Xin LEI, Xi'an (CN); Guanzheng QU, Xi'an (CN)

(21) Appl. No.: 17/028,730

(22) Filed: Sep. 22, 2020

Related U.S. Application Data
(63) Continuation-in-part of application No. 16/240,738, filed on Jan. 5, 2019, now abandoned.

(30) Foreign Application Priority Data
Dec. 7, 2018 (CN) 201811495751.X

(51) Int. Cl. E21B 43/26; E21B 33/138; E21B 41/00

(52) U.S. Cl. CPC E21B 43/261; E21B 43/267; E21B 41/00; E21B 33/138

(57) ABSTRACT

A method for creating branch fractures in an oil well, including: injecting a first pad fluid containing a first absorbent resin to a first position of the main fracture; injecting a second pad fluid containing a second absorbent resin to a second position of the main fracture; after the second absorbent resin absorbs water and expands to form a first plugging layer, injecting a third pad fluid free of absorbent resin to the main fracture to build up a pressure at the first plugging layer; exerting the pressure to sides of the main fracture to form a first branch fracture; breaking the first plugging layer to generate a fragment; bridging the fragment to the first absorbent resin to form a second plugging layer; and injecting a third pad fluid to build up a pressure to form a second branch fracture at the first position.

### CROSS-REFERENCE TO RELATED APPLICATIONS

This application is a continuation-in-part application of U.S. patent application Ser. No. 16/240,738, filed on Jan. 5, 2019, which claims the benefit of priority from Chinese Patent Application No. 201811495751.X, filed on Dec. 7, 2018. The content of the aforementioned application, including any intervening amendments thereto, is incorporated herein by reference in its entirety.

### TECHNICAL FIELD

This application relates to fracking, and more particularly to a method for creating branch fractures in an oil well.

### BACKGROUND OF THE DISCLOSURE

With the acceleration of the exploration and development of unconventional oil and gas resources, such as tight oil, shale gas and coal bed methane, how to effectively exploit the unconventional oil and gas resources has received wide consideration, where hydraulic fracturing has been demonstrated to be an effective method for economically developing the unconventional oil and gas resources. In order to form sand packed fractures with high conductivity to dramatically improve the output of oil and gas wells, it is essential to stimulate a complex fracture network in the subterranean formation. The existing hydraulic fracturing techniques usually fail to form a multistage and complex fracture network in the oil and gas enrichment reservoir, failing to obviously enhance the oil and gas production after the fracturing.

### SUMMARY OF THE DISCLOSURE

An object of this disclosure is to provide a method for creating branch fractures in an oil well to overcome the defect in the prior art that the conventional hydraulic fracturing techniques usually fail to form a multistage and complex fracture network in the oil and gas enrichment reservoirs, failing to significantly enhance the oil and gas production after the fracturing.

The disclosure is achieved by adopting the following technical solutions.

The disclosure provides a method for creating branch fractures in an oil well, comprising:

(1) creating a main fracture in the oil well;

(2) injecting a first pad fluid comprising a first absorbent resin to a first position of the main fracture; and injecting a second pad fluid comprising a second absorbent resin to a second position of the main fracture; wherein a water absorption rate of the second absorbent resin is larger than that of the first absorbent resin; and a distance between the second position and an opening of the main fracture is smaller than a distance between the first position and the opening of the main fracture;

(3) after the second absorbent resin absorbs water and expands to form a first plugging layer at the second position, injecting a third pad fluid free of absorbent resin to the main fracture to build up a pressure at the first plugging layer; exerting the pressure to two sides of the main fracture to form a first branch fracture at the second position; and

(4) increasing an injection pressure of the third pad fluid to break the first plugging layer to generate a fragment; carrying the fragment through the third pad fluid to the first position to allow the fragment to be bridged to the first absorbent resin to form a second plugging layer; injecting the third pad fluid to the main fracture to build up a pressure at the second plugging layer; and exerting the pressure to two sides of the main fracture to form a second branch fracture at the first position.

In some embodiments, the first absorbent resin is starch grafted polyacrylamide or cellulose grafted polyacrylamide.

In some embodiments, the second absorbent resin is an acrylic acid-containing terpolymer.

In some embodiments, in the case that the second absorbent resin fails to form the first plugging layer after absorbing water, a fourth pad fluid comprising a third absorbent resin is injected to the main fracture to allow a pressure in the main fracture to continuously rise until the first plugging layer is formed, wherein the third absorbent resin is larger than the second pad fluid in particle size; and a particle size of the third absorbent resin is greater than 1 mm and a mass percentage of the third absorbent resin in the fourth pad fluid is 3%-5%.

In some embodiments, the third absorbent resin is an acrylic acid-containing terpolymer.

In some embodiments, in step (3), after the third pad fluid is injected to build up the pressure at the first plugging layer, when the pressure is raised to a fracturing pressure of side walls of the main fracture and then begins to decline, the third pad fluid is continuously injected to extend the first branch fracture.

In some embodiments, in step (4), before the first plugging layer is broken to generate the fragment, when the pressure in the main fracture is larger than a preset pressure, a fifth pad fluid comprising an additive is injected to the main fracture to accelerate the breaking of the first plugging layer.

In some embodiments, the additive is sodium chloride or ammonium persulfate.

In some embodiments, in step (4), after the third fluid is injected to build up the pressure at the second plugging layer, when the pressure is raised to a fracturing pressure of side walls of the main fracture and then begins to decline, the third fluid is injected continuously to extend the second branch fracture.

In some embodiments, the method further comprises:

after step (4), injecting a sixth pad fluid comprising a dissolving agent to the main fracture to dissolve the second plugging layer.

In some embodiments, the dissolving agent comprises ammonium persulfate and hydrochloric acid.

In some embodiments, the method further comprises:

after step (4), injecting a proppant-carrying fluid to pack the main fracture, the first branch fracture and the second branch fracture.

In some embodiments, the method further comprises:

after step (4), sucking fluids in the main fracture, the first branch fracture and the second branch fracture by a suction machine to perform flowback.

Compared with the prior art, this disclosure has the following beneficial effects.

The invention employs two absorbent resins varying in water adsorption to respectively form a temporary plugging layer at different positions of the main fracture, and then injects a pad fluid to build up pressure at the plugging layers to create multiple branch fractures at different positions of the main fracture, which enables the stimulated oil well to have a multistage and complex fracture network, expanding the area of the stimulated reservoir and significantly enhancing the oil and gas production.

### BRIEF DESCRIPTION OF THE DRAWINGS

The technical solutions in the prior art or in embodiments of the disclosure will be more clearly described below with reference to the drawings. Obviously, depicted in the drawings below are merely some embodiments of the disclosure, and other drawings can be obtained by those skilled in the art based on the drawings provided herein without sparing any creative effort.

FIG. 1 schematically shows the creation of a first branch fracture in a main fracture according to an embodiment of the invention.

FIG. 2 schematically shows the creation of a second branch fracture in the main fracture according to an embodiment of the invention.

In the drawings: 100—oil well; 1—main fracture; 2—first position; 3—first absorbent resin; 4—second position; 5—second absorbent resin; 6—opening of the main fracture; 7—first plugging layer; 8—first branch fracture; 9—fragment; 10—second plugging layer; and 11—second branch fracture.

### DETAILED DESCRIPTION OF EMBODIMENTS

The technical solutions of the present disclosure will be clearly and fully described with reference to the accompanying drawings and embodiments. Obviously, described below are merely some embodiments of the disclosure. It should be noted that various replacements, changes and modifications made by those skilled in the art without departing from the spirit of the disclosure should fall within the scope of the disclosure.

It should be noted that all directional terms in the embodiments of the disclosure, such as “above”, “below”, “left”, “right”, “front” and “rear”, are merely illustrative of relative positions and movement conditions of various parts involved in an embodiment depicted in the drawing.

Moreover, terms such as “first” and “second” are merely illustrative of the invention, and should not be interpreted as indication or implication of relative importance or the number of the technical features. Therefore, a feature defined by “first” or “second” may include at least one of the features explicitly or implicitly. Besides, the term “and/or” used herein includes three conditions. For example, “A and/or B” refers to A, B, or both A and B. In addition, technical solutions of individual embodiments can be combined on the premise that the combined solutions can be implemented by those skilled in the art.

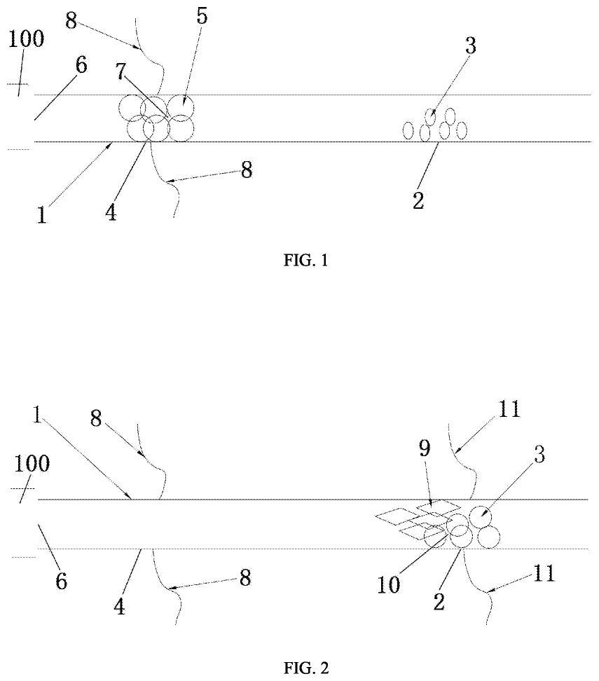

As shown in FIGS. 1 and 2, this disclosure provides a method for creating branch fractures in an oil well, including the following steps.

1) A main fracture 1 is created in the oil well 100.

Specifically, a fracturing packer is set in the oil well 100, and a third pad fluid free of absorbent resin is injected to the oil well 100 to fracture a target layer to form the main fracture 1.

It should be noted that the pad fluid is commonly used in the hydraulic fracturing of oil wells to exert pressure to the rocks to create fractures. In this embodiment, the third pad fluid is free of absorbent resins, additives and dissolving agents.

2) A first pad fluid containing a first absorbent resin 3 is injected to a first position 2 of the main fracture 1, and then a second pad fluid containing a second absorbent resin 5 is injected to a second position 4 of the main fracture 1, where a water absorption rate of the second absorbent resin 5 is larger than that of the first absorbent resin 3, and a distance between the second position 4 and an opening of the main fracture 1 is smaller than that between the first position 2 and the opening 6 of the main fracture 1.

It should be noted that the first and second absorbent resins used herein both pertain to superabsorbent polymers (SAP), which are novel polymer materials capable of absorbing and retaining liquids several times larger than its own weight. SAP is a commercially available hydrogel which absorbs a liquid through the formation of hydrogen bonds with water molecules. In this embodiment, SAP has a water absorbency of larger than 10 g/g, where the unit g/g refers to the ratio of the mass of the SAP after fully absorbing water to that before water absorbing. For example, 30 g/g represents that 1 g of SAP has a mass of 30 g after completely absorbing water.

In some embodiments, the first absorbent resin 3 is starch grafted polyacrylamide or cellulose grafted polyacrylamide. The starch grafted polyacrylamide has a water absorbency of 30 g/g-80 g/g, a particle size of 0.5 mm-2 mm, and a compressive strength of 0.05 MPa-1 MPa after per cubic centimeter thereof is saturated with salt water. The cellulose grafted polyacrylamide has a water absorbency of 40 g/g-85 g/g, a particle size of 0.5 mm-2 mm, and a compressive strength of 0.04 MPa-1.2 MPa after per cubic centimeter thereof is saturated with salt water. The compressive strength refers to the pressure that 1 cm³ of SAP can bear after saturated with 0.9% (mass percentage) sodium chloride.

In some embodiments, the second absorbent resin 5 is an acrylic acid-containing terpolymer, where the acrylic acid-containing terpolymer has a water absorbency of 150 g/g-270 g/g, a particle size of 0.5 mm-1.5 mm, and a compressive strength of 0.01 MPa-0.05 MPa after per cubic centimeter thereof is saturated with salt water.

It should be noted that the starch grafted polyacrylamide, cellulose grafted polyacrylamide and acrylic acid-containing terpolymer are commercially available.

Specifically, the first pad fluid containing 2%-8% by weight of the first absorbent resin 3 is injected to the main fracture 1 at a speed of 3 m³/min-10 m³/min. The third pad fluid is injected into the main fracture 1 to replace the first pad fluid and push the first pad fluid to the first position 2. Then the second pad fluid containing 10%-15% by weight of the second absorbent resin 5 is injected to the second position 4 of the main fracture 1 at a speed of 1 m³/min-3 m³/min.

3) After the second absorbent resin 5 absorbs water and expands to form a first plugging layer 7, the third pad fluid is injected to the main fracture 1 to build up a pressure at the first plugging layer 7, which is exerted to two sides of the main fracture 1 to form a first branch fracture 8 at the second position 4, further creating a multistage and complex fracture network to expand the reservoir area in the stimulated oil well 100 and obviously enhance the oil and gas production.

It should be noted that in this disclosure, the main fracture 1 is temporarily plugged, which is different from the permanent plugging in the prior art. After the desired branch fractures are formed, the plugging layer is broken and removed. The pressure buildup indicates that after the main fracture 1 is temporarily plugged, the pressure in the main fracture 1 is raised to a fracturing pressure of rocks, and thus the rocks are fractured to form branch fractures.

Specifically, the third pad fluid is injected to the main fracture 1 at a speed of 5 m³/min-15 m³/min.

In some embodiments, after the second absorbent resin 5 absorbs water and expands, the pressure in the main fracture 1 is measured. When the pressure in the main fracture 1 keeps rising, it indicates that the first temporary plugging layer 7 is formed. When the pressure in the main fracture 1 fails to continuously rise, it indicates that the amount of the second absorbent resin 5 is insufficient to form the first temporary plugging layer 7. At this time, a fourth pad fluid containing 3%-5% by weight of a third absorbent resin is injected to the main fracture 1 to allow the pressure in the main fracture 1 to continuously rise until the first temporary plugging layer 7 is formed, where the third absorbent resin is an acrylic acid-containing terpolymer with a particle size larger than the second absorbent resin 5. The pressure in the main fracture 1 is measured in real time to ensure that the second absorbent resin 5 forms the first temporary plugging layer 7 at the second position 4.

In some embodiments, after the third pad fluid is injected to the main fracture 1 to build up the pressure at the first temporary plugging layer 7, when the pressure in the main fracture 1 is raised to the fracturing pressure of rocks and then begins to reduce, it indicates that the first branch fracture 8 is created at the second position 4. The third pad fluid can be further injected to the main fracture 1 at a speed of 2 m³/min-5 m³/min to extend the first branch fracture 8, expanding the reservoir area in the stimulated oil well 100 to significantly enhance the oil and gas production.

4) The first temporary plugging layer 7 is broken to generate a fragment 9. The fragment 9 was carried by the third pad fluid to be bridged to the first absorbent resin 3 to form a second temporary plugging layer 10. The third pad fluid is continuously injected to the main fracture 1 to build up the pressure at the second temporary plugging layer 10, which is exerted to both sides of the main fracture 1 to form a second branch fracture 11 at the first position 2, further creating a multistage and complex fracture network at the first position 2 to expand the reservoir area in the oil well 100 and significantly enhance the oil and gas production.

It should be noted that the bridging refers to a process that after the first temporary plugging layer 7 is broken into the fragment 9 of various sizes and shapes, the third pad fluid carries the fragment 9 to the first position 2 of the main fracture 1, and after arriving at the first position 2, the fragment 9 is blocked by the first absorbent resin 3 and forms the second temporary plugging layer 10 together with the first absorbent resin 3, plugging the main fracture 1.

Specifically, an injection pressure of the third pad fluid is increased at a rate of 0.2 MPa/s to press and break the first temporary blocking layer 7 to form the fragment 9. The third pad fluid is injected to the main fracture 1 at a speed of 2 m³/min-5 m³/min to carry the fragment 9 to the first position 2. The fragment 9 are bridged to the first absorbent resin 3 which has absorbed water to expand at the first position 2 to form the second temporary plugging layer 10. The third pad fluid is injected to the main fracture 1 at a speed of 5 m³/min-15 m³/min to build up the pressure at the second temporary plugging layer 10, which is exerted to both sides of the main fracture 1 to form the second branch fracture 11 at the first position 2.

In some embodiments, the pressure in the main fracture 1 is measured in real time, and when the pressure reaches a collapse pressure of the first temporary plugging layer 7 and begins to reduce at a speed of 0.5 MPa/s or more, it indicates that the first temporary plugging layer 7 has been broken. In the case that the pressure in the main fracture 1 is measured to be larger than a preset pressure, a fifth pad fluid containing an additive is injected to the main fracture 1 to accelerate the breaking of the first temporary plugging layer 7.

In some embodiments, the additive is sodium chloride or ammonium persulfate. The fifth pad fluid contains 0.05%-1% by weight of sodium chloride or 10%-15% by weight of ammonium persulfate.

Specifically, when the pressure in the main fracture 1 rises to 65 MPa, the fifth pad fluid containing 0.05%-1% by weight of sodium chloride or is injected to the main fracture 1 to dehydrate the second super absorbent resin 5 to accelerate the fracturing of the first temporary plugging layer 7 to break and collapse; or the fifth pad fluid containing 10%-15% by weight of ammonium persulfate is injected to the main fracture 1 to dissolve the second absorbent resin 5 to accelerate the fracturing of the first temporary plugging layer 7.

In some embodiments, after the pressure is built up at the second temporary plugging layer 10 by injecting the third fluid to the main fracture 1, when the pressure reaches the fracturing pressure of rocks and begins to reduce, it indicates that the second branch fracture 11 is created at the first position 2. The third pad fluid can be further injected to the main fracture 1 at a speed of 2 m³/min-5 m³/min to extend the second branch fracture 11, expanding the reservoir area in the stimulated oil well 100 to significantly enhance the oil and gas production.

The introduction of absorbent resins to form the temporary plugging layers in this disclosure has the following beneficial effects. 1. The super absorbent resin has a low price and a good temporary plugging effect. 2. The granular super absorbent resin can be added at any time when required. 3. After absorbing water, the super absorbent resin will experience significant increase in volume to form a temporary plugging layer with excellent plugging effect. 4. The super absorbent resin is environmentally friendly, and will not cause pollution to the reservoir of the oil well 100 during the fracturing process.

In some embodiments, the method further includes the following steps.

5) A sixth pad fluid containing a dissolving agent is injected to the main fracture 1 to dissolve the second temporary plugging layer 10. The dissolving agent can dissolve the second super absorbent resin 5 and the first super absorbent resin 3 in the main fracture 1, the first branch fracture 8 and the second branch fracture 11 to ensure the flow conductivities of the main fracture 1, the first branch fracture 8 and the second branch fracture 11.

It should be noted that the sixth pad fluid can be pumped to the main fracture 1 by a pump set, which provides the sixth pad fluid with a stronger impact force, so that it can further dissolve the main fracture 1, the first branch fracture 8 and the second branch fracture 11 after dissolving the second temporary plugging layer 10, expanding the reservoir area in the oil well 100 to obviously enhance the oil and gas production.

In some embodiments, the dissolving agent includes ammonium persulfate and hydrochloric acid. The sixth pad fluid contains 15%-25% by weight of ammonium persulfate and 5%-10% by weight of hydrochloric acid.

In some embodiments, the method further includes the following steps.

6) A proppant-carrying fluid is injected to the main fracture 1 to pack the main fracture 1, the first branch fracture 8 and the second branch fracture 11.

In some embodiments, the method further includes the following steps.

7) The fluids in the main fracture 1, the first branch fracture 8 and the second branch fracture 11 is sucked by a suction machine to perform flowback, reducing the pollution of chemicals in the pad fluid to the formation.

The invention employs two absorbent resins varying in water adsorption to respectively form a temporary plugging layer at different positions of the main fracture 1, and then injects a pad fluid to build up pressure at the plugging layers to create multiple branch fractures at different positions of the main fracture 1, which enables the stimulated oil well to have a multistage and complex fracture network, expanding the area of the stimulated reservoir and significantly enhancing the oil and gas production.

The principles of the invention are specifically described as follows.

Due to the smaller water absorbency of the first absorbent resin 3, the first pad fluid containing the first absorbent resin 3 is first injected to the main fracture 1 and then pushed to the first position 2 of the main fracture 1. Then, the second pad fluid containing the second absorbent resin 5 with relatively larger water absorbency is injected to the main fracture 1 to form the first temporary plugging layer 7 at the second position 4 of the main fracture 1. The third pad fluid is injected to build up a pressure at the first temporary blocking layer 7 to create the first branch fracture 8. The compressive strength of the first temporary plugging layer 7 is reduced as the water absorption amount of the second absorbent resin 5 increases. After the first branch fracture 8 is created, the injection pressure of the third pad fluid is increased to allow the first temporary plugging layer 7 to break and collapse to generate the fragment 9, which is carried by the third pad fluid to move to the first position 2 of the main fracture 1 to be bridged to the first absorbent resin 3 to form the second temporary plugging layer 10. The third pad fluid is injected to build up a pressure at the second temporary plugging layer 10 to create the second branch fracture 11.

The disclosure will be further described in detail with reference to the accompanying drawings and embodiments.

### Example 1

This embodiment provides a method for creating branch fractures in an oil well, including the following steps.

1) A main fracture 1 is created in the oil well 100.

2) A first pad fluid containing 4% by weight of the first absorbent resin 3 is injected to the main fracture 1 at a rate of 4.5 cm³/min, where the first absorbent resin 3 is starch grafted polyacrylamide having a water absorbency of 45 g/g, a particle size of 0.7 mm, and a compressive strength of 0.06 MPa after per cubic centimeter thereof is saturated with salt water. Then, a third pad fluid free of absorbent resin is injected to replace the first pad fluid to a first position 2. A second pad fluid containing 10% by weight of a second absorbent resin 5 is injected to a second position 4 of the main fracture 1 at a speed of 1.5 m³/min, where the second absorbent resin 5 is an acrylic acid-containing terpolymer having a water absorbency of 175 g/g, a particle size of 0.5 mm, and a compressive strength of 0.02 MPa after per cubic centimeter thereof is saturated with salt water. The oil well 100 is shut in for 2 min to allow the second super absorbent resin 5 to absorb water and expand completely.

3) The second absorbent resin 5 absorbs water and expands completely at the second position 4 to form a first temporary plugging layer 7. The third pad fluid is injected to the main fracture 1 at a speed of 6.5 m³/min to build up a pressure at the first temporary plugging layer 7, which is exerted to both sides of the main fracture 1 to form a first branch fracture 8 at the second position 4. Then the third pad fluid is injected to the main fracture 1 at a speed of 2 m³/min to extend the first branch fracture 8.

4) After the first branch fracture 8 is created, an injection pressure of the third pad fluid is increased at a rate of 0.2 MPa/s to fracture the first temporary plugging layer 7 to generate the fragment 9. The third pad fluid is injected to the main fracture 1 at a speed of 2 m³/min to carry the fragment 9 to the first position 2. The fragment 9 is bridged to the first absorbent resin 3 which has absorbed water and expanded at the first position 2 to form the second temporary plugging layer 10. The third pad fluid is injected to the main fracture 1 at a speed of 8.5 m³/min to build up the pressure at the second temporary plugging layer 10, which is exerted to both sides of the main fracture 1 to form the second branch fracture 11 at the first position 2. Then the third pad fluid is injected at a speed of 3 m³/min to extend the second branch fracture 11.

5) A fourth pad fluid containing 17% by weight of ammonium persulfate and 7% by weight of hydrochloric acid is injected to the main fracture 1 to dissolve the second temporary plugging layer 10.

6) A proppant-carrying fluid is injected to pack the main fracture 1, the first branch fracture 8 and the second branch fracture 11.

7) Fluids in the main fracture 1, the first branch fracture 8 and the second branch fracture 11 are sucked by a suction machine to perform flowback.

It has been found that complex fracture networks have been created at the second position 4 and first position 2, respectively, allowing expansion in the reservoir area in the oil well 100 and significantly enhancing the oil and gas production.

### Example 2

This embodiment provides a method for creating branch fractures in an oil well, including the following steps.

1) A main fracture 1 is created in the oil well 100.

2) A first pad fluid containing 7% by weight of the first absorbent resin 3 is injected to the main fracture 1 at a rate of 5.5 cm³/min, where the first absorbent resin 3 is starch grafted polyacrylamide having a water absorbency of 75 g/g, a particle size of 1.5 mm, and a compressive strength of 1.2 MPa after per cubic centimeter thereof is saturated with salt water. Then, a third pad fluid free of absorbent resin is injected to replace the first pad fluid to a first position 2. A second pad fluid containing 15% by weight of a second absorbent resin 5 is injected to a second position 4 of the main fracture 1 at a speed of 2.5 m³/min, where the second absorbent resin 5 is an acrylic acid-containing terpolymer having a water absorbency of 245 g/g, a particle size of 1.2 mm, and a compressive strength of 0.05 MPa after per cubic centimeter thereof is saturated with salt water. The oil well 100 is shut in for 1.5 min to allow the second super absorbent resin 5 to absorb water and expand completely.

3) The second absorbent resin 5 absorbs water and expands completely at the second position 4 to form a first temporary plugging layer 7. The third pad fluid is injected to the main fracture 1 at a speed of 5.5 m³/min to build up a pressure at the first temporary plugging layer 7, which is exerted to both sides of the main fracture 1 to form a first branch fracture 8 at the second position 4. Then the third pad fluid is injected to the main fracture 1 at a speed of 3 m³/min to extend the first branch fracture 8.

4) After the first branch fracture 8 is created, an injection pressure of the third pad fluid is increased at a rate of 0.2 MPa/s to fracture the first temporary plugging layer 7 to generate the fragment 9. The third pad fluid is injected to the main fracture 1 at a speed of 3 m³/min to carry the fragment 9 to the first position 2. The fragment 9 is bridged to the first absorbent resin 3 which has absorbed water and expanded at the first position 2 to form the second temporary plugging layer 10. The third pad fluid is injected to the main fracture 1 at a speed of 7.5 m³/min to build up the pressure at the second temporary plugging layer 10, which is exerted to both sides of the main fracture 1 to form the second branch fracture 11 at the first position 2. Then the third pad fluid is injected at a speed of 3 m³/min to extend the second branch fracture 11. 5) A fourth pad fluid containing 21% by weight of ammonium persulfate and 4% by weight of hydrochloric acid is injected to the main fracture 1 to dissolve the second temporary plugging layer 10.

6) A proppant-carrying fluid is injected to pack the main fracture 1, the first branch fracture 8 and the second branch fracture 11.

7) Fluids in the main fracture 1, the first branch fracture 8 and the second branch fracture 11 are sucked by a suction machine to perform flowback.

It has been found that complex fracture networks have been created at the second position 4 and first position 2, respectively, allowing expansion in the reservoir area in the oil well 100 and significantly enhancing the oil and gas production.

Described above are merely preferred embodiments of the disclosure, which are not intended to limit the disclosure. Any modifications, replacements and variations made by those skilled in the art based on the content disclosed herein without paying any creative effort should fall within the scope of the disclosure defined by the appended claims.

What is claimed is:

1. A method for creating branch fractures in an oil well, comprising:
(1) creating a main fracture in the oil well;
(2) injecting a first pad fluid comprising a first absorbent resin to a first position of the main fracture; and injecting a second pad fluid comprising a second absorbent resin to a second position of the main fracture; wherein a water absorption rate of the second absorbent resin is larger than that of the first absorbent resin; and a distance between the second position and an opening of the main fracture is smaller than a distance between the first position and the opening of the main fracture;
(3) after the second absorbent resin absorbs water and expands to form a first plugging layer at the second position, injecting a third pad fluid free of absorbent resin to the main fracture to build up a pressure at the first plugging layer; exerting the pressure to two sides of the main fracture to form a first branch fracture at the second position; and
(4) increasing an injection pressure of the third pad fluid to break the first plugging layer to generate a fragment; carrying the fragment through the third pad fluid to the first position to allow the fragment to be bridged to the first absorbent resin to form a second plugging layer; injecting the third pad fluid to the main fracture to build up a pressure at the second plugging layer; and exerting the pressure to two sides of the main fracture to form a second branch fracture at the first position.

2. The method of claim 1, wherein the first absorbent resin is starch grafted polyacrylamide or cellulose grafted polyacrylamide.

3. The method of claim 1, wherein the second absorbent resin is an acrylic acid-containing terpolymer.

4. The method of claim 1, wherein in the case that the second absorbent resin fails to form the first plugging layer after absorbing water, a fourth pad fluid comprising 3%-5% by weight of a third absorbent resin is injected to the main fracture to allow a pressure in the main fracture to continuously rise until the first plugging layer is formed, wherein the third absorbent resin is an acrylic acid-containing terpolymer and is larger than the second absorbent resin in particle size.

5. The method of claim 1, wherein in step (3), after the third pad fluid is injected to build up the pressure at the first plugging layer, when the pressure is raised to a fracturing pressure of side walls of the main fracture and then begins to decline, the third pad fluid is continuously injected to extend the first branch fracture.

6. The method of claim 1, wherein in step (4), before the first plugging layer is broken to generate the fragment, when the pressure in the main fracture is larger than a preset pressure, a fifth pad fluid comprising an additive is injected to the main fracture to accelerate the breaking of the first plugging layer.

7. The method of claim 6, wherein the additive is sodium chloride or ammonium persulfate.

8. The method of claim 1, wherein in step (4), after the third fluid is injected to build up the pressure at the second plugging layer, when the pressure is raised to a fracturing pressure of side walls of the main fracture and then begins to decline, the third fluid is injected continuously to extend the second branch fracture.

9. The method of claim 1, further comprising:
after step (4), injecting a sixth pad fluid comprising a dissolving agent to the main fracture to dissolve the second plugging layer.

10. The method of claim 9, wherein the dissolving agent comprises ammonium persulfate and hydrochloric acid.

11. The method of claim 1, further comprising:
after step (4), injecting a proppant-carrying fluid to pack the main fracture, the first branch fracture and the second branch fracture.

12. The method of claim 1, further comprising:
after step (4), sucking fluids in the main fracture, the first branch fracture and the second branch fracture by a suction machine to perform flowback.
